(19) United States
(12) Patent Application Publication
(10) Pub. No.: US 2007/0132703 A1
(43) Pub. Date: Jun. 14, 2007

(54) Display device

(76) Inventors: Hiroko Sehata, Mobara (JP); Hiroaki Asuma, Mobara (JP); Atsushi Hasegawa, Togane (JP); Norio Mamba, Kawasaki (JP); Yukari Katayama, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/637,723

(22) Filed: Dec. 13, 2006

(30) Foreign Application Priority Data
Dec. 14, 2005 (JP) 2005-359799

(51) Int. Cl. G09G 3/36

(52) U.S. Cl. 345/100

(57) ABSTRACT

To take aim at low power consumption when controlling display/non-display in an arbitrary area. A display panel including a plurality of scanning lines and a plurality of signal lines, and a drive circuit which drives the display panel are provided, and the drive circuit has shift resister circuits sequentially outputting the first to the order of “n” (n≧2) shift pulses at each prescribed period based on transfer clocks to be inputted, “n” pieces of first transistors in which the first to the order of “n” shift pulses outputted from the shift resister circuits are applied to gates respectively, and “n” pieces of signal line scanning circuits, and the respective first transistors perform sampling of scanning line drive clocks and output them as scanning voltages for the first to the order of “n” scanning lines based on the first to the order of “n” shift pulses outputted from the shift register circuits, and the respective signal line scanning circuits output the prescribed voltages for a first to the order of “n” signal lines based on the first to the order of “n” shift pulses outputted from the shift register circuit, an alternation signal, an inverting alternation signal and the transfer clocks.

The present application claims priority from Japanese application JP2005-359799 filed on Dec. 14, 2005, the content of which is hereby incorporated by reference into this application.

### BACKGROUND OF THE INVENTION

1. Field of the Invention

The invention relates to a display device such as a liquid crystal display module, especially, relates to an efficient technique to be applied to a scanning line drive circuit of the display device.

2. Description of the Related Art

A TFT (Thin Film Transistor) liquid crystal display module having a small liquid crystal display panel is widely used as displays of portable devices such as a cellular phone.

In the cellular phone, as a display screen during standby, for example, as shown in FIG. 17 a case in which a clock and the like are displayed at a part of the screen (an upper side denoted by “A” in FIG. 17) and a monochromatic black screen and the like are displayed at other regions (a region denoted by “B” in FIG. 17) is supposed.

Since the case is during standby, it is required that the screen is displayed in low power consumption. And the part of the screen is black screen, therefore, it is possible to drive in low power consumption (so-called a partial display drive) by reducing a writing cycle of pixels to the black part and the like.

Hereinafter, the partial display drive and alternation of liquid crystal will be explained with reference to FIG. 18A to FIG. 18D.

Since it is difficult for the liquid crystal to keep applying DC electric field for a long time, alternation, that is, to change the direction of the DC electric field in a certain cycle becomes necessary.

There are a common symmetry method (for example, a dot inversion and the like) and a common inversion method in the alternation. The common conversion method in the above methods is broadly classified into a line inversion and a frame inversion.

In the frame inversion, alternation is performed at one vertical period (frame) of display, and alternation is performed at one horizontal period in the line inversion. In this case, the frame inversion will be explained.

FIG. 18A shows a frame of starting the partial drive, “+” and “−” in the screen indicate that DC electric fields in opposite directions to each other are applied to the liquid crystal. That is, change from “+” to “−”, or change from “−” to “+” indicates that the alternation is performed.

In FIG. 18A, signals are written in pixels in the direction “+” at both a display part and a black part.

In FIG. 18B, video signals are written only in the display part and the alternation is performed (“−” writing), however, in the black part, writing in pixels is not newly performed and the pixel signal written in the first frame of FIG. 18A is held. Since new writing is not performed, the alternation of the black part is not performed and “+” is maintained. The new writing is not performed, therefore, a liquid crystal panel will be low in power consumption.

In the third frame of FIG. 18C, a new writing to pixels is not performed on the black display part in the same way as the second frame of FIG. 18B, and only the display part is inverted.

In the fourth frame of FIG. 18D, the black part is newly written by “−” together with the display part.

Accordingly, the display part performs alternation in respective frames as shown in FIG. 18A to FIG. 18D, and an alternation cycle is two frames. On the other hand, the black part performs alternation once in three frames, therefore, the alternation cycle is six frames.

Hereinafter, in the specification, the method of alternation shown in FIG. 18A to FIG. 18D will be explained as a basic partial display drive.

FIG. 19 is a block diagram showing a schematic configuration of a conventional IPS liquid crystal display panel and a scanning line drive circuit.

The liquid crystal display panel shown in FIG. 19 includes a plurality of subpixels. In FIG. 20, an equivalent circuit of a subpixel of the liquid crystal display panel shown in FIG. 19 will be shown.

In FIG. 20, COMn denotes a counter electrode line (also referred to as a common line), Gn denotes a scanning line (also referred to as a gate line), Sn denotes a video line (also referred to as a source line, a drain line), TFT denotes a thin-film transistor as an active element, PIX denotes a pixel electrode and ITO2 denotes a counter electrode.

The pixel electrode (PIX) and the counter electrode (ITO2) are formed on the same substrate in the liquid crystal display panel shown in FIG. 19, which is so-called the IPS liquid crystal display panel in which voltage is applied between the pixel electrode (PIX) and the counter electrode (ITO2) to display images on the display part.

In the liquid crystal display panel shown in FIG. 19, a selection scanning voltage is supplied to each scanning line (Gn) at each one horizontal scanning time. Accordingly, the thin-film transistors (TFT) connected to each scanning line (GN) are turned on during one horizontal scanning time, and a voltage corresponding to display data is applied to respective pixel electrodes (PIX) from a video line drive circuit (source driver; SDIV) through video lines (Sn).

Corresponding to the above, a high-level (hereinafter, referred to as “H” level) common voltage (VCOMH) or a low-level (hereinafter, referred to as “L” level) common voltage (VCOML) is applied to the counter electrodes (ITO2). Accordingly, images are displayed on the liquid crystal display panel.

In FIG. 19, T-0 to T-n denote shift register circuits of (n+1) stages, M1 to M3 are transistors and C-1 to C-n+1 denote counter electrode scanning circuits of (n+1) stages.

FIG. 21A to FIG. 21B are views showing timing charts of the scanning line drive circuit shown in FIG. 19. Hereinafter, the operation of the scanning line drive circuit shown in FIG. 19 will be simply explained with reference to FIG. 21A and FIG. 21B.

As shown in FIG. 21A and FIG. 21B, a start pulse (Vin) and transfer clocks V1 and V2 are inputted to the shift register circuits (T-0 to T-n), shift pulses synchronized with the transfer clock (V1) are outputted from shift register circuits of even stages, and shift pulses synchronized with the transfer clock (V2) are outputted from shift register circuits of odd stages.

The transfer clock (V1) and the transfer clock (V2) have the same cycle (two horizontal periods in this case) and different phases by 180 degrees, therefore, shift pulses (Tout-0 to Tout-n) are sequentially outputted at each one horizontal period from the shift register circuits (T-0 to T-n).

The shift pulses (Tout-0 to Tout-n) are applied to gates of transistors (M1) at respective shift stages, and the transistors (M1) are turned on when the shift pulses (Tout-0 to Tout-n) are applied.

The transfer clock (V1) is applied to drains of transistors (M1) of even stages and the transfer clock (V2) is applied to drains of transistors (M1) of odd stages.

According to this, a selection scanning voltage which turns on the thin-film transistors (TFT) during one horizontal period is sequentially outputted to the scanning lines (G1 to Gn) at each one horizontal scanning period.

The counter electrode scanning circuits (C-1 to C-n+1) have a function as switching circuits outputting the H-level common voltage (VCOMH) or the L-level common voltage (VCOML) with respect to the counter electrode lines (COM1 to COMn+1).

For example, the counter electrode scanning circuit (C-1) determines which of the H-level common voltage (VCOMH) and the L-level common voltage (VCOML) is outputted based on an alternation signal (M) and an inverting alternation signal (MB) inputted through the transistors (M1, M2) which are turned on by the selection scanning voltage of the scanning line of a previous stage (scanning line “G0” in this case), and outputs either the H-level common voltage (VCOMH) or the L-level common voltage (VCOML) to the counter electrode line (COM1 to COMn+1) by inputting a selection scanning voltage of the scanning line of this stage (scanning line “G1” in this case) as an enable signal (E).

That is to say, as shown in FIG. 21A, when the alternation signal (M) and the inverting alternation signal (MB) are switched at each one horizontal period, cycles of the H-level common voltage (VCOMH) and the L-level common voltage (VCOML) are switched at each one horizontal period, which is the line inversion drive.

In addition, as shown in FIG. 21B, when the alternation signal (M) and the inverting alternation signal (MB) are switched at each one frame, cycles of the H-level common voltage (VCOMH) and the L-level common voltage (VCOML) are switched at each one frame, which is the frame inversion.

In view of power consumption, the line inversion in which the alternation signal (M) and the inverting alternation signal (MB) have high frequencies is high in power consumption, whereas the frame inversion having low signal frequencies is low in power consumption.

However, generally, the frame inversion drive has some problems in image quality such as occurrence of cross-talk and the like, therefore, the line inversion is often used in normal displays.

The scanning line drive circuit for realizing the partial drive which has been explained in FIG. 18A to FIG. 18D is disclosed, for example, in the following patent document 1.

There are related art documents relating to the invention as follows:

[Patent document 1] JP-A-2002-351414

[Patent document 2] JP-A-2005-173244

### SUMMARY OF THE INVENTION

The scanning line drive circuit disclosed in the patent document 1 includes a scanning line drive circuit which scans and drives scanning lines sequentially based on potentials of output nodes of level shifter circuits, and the scanning line drive circuit performs mask control by output enable signals XOEV inputted according to scanning timings of the scanning lines of blocks of non-display areas which are set based on blocks divided by the given plural scanning lines as units, which realizes partial drive.

However, in the scanning line drive circuit disclosed in the patent document 1, there is a problem, for example, that it is difficult to control the common voltage outputted to the counter electrode line by each one display line independently, such as in the IPS liquid crystal display panel and the like.

Additionally, in the scanning drive circuit shown in FIG. 19, there is a problem that it is difficult to perform control during the partial display drive.

In order to perform the basic partial display drive, it is necessary that the black part holds pixel signals during three frames as explained in FIG. 18A to FIG. 18B.

In order to hold pixel signals, it is necessary that the black part in frames of FIG. 18B and FIG. 18C outputs a non-selection scanning voltage to scanning lines. However, in the scanning drive circuit shown in FIG. 19, the non-selection scanning voltage can not be outputted to the scanning lines.

This is because the transfer clocks (V1, V2) are used also as the transfer signals of the shift register, the selection scanning signal and an operation signal for the counter electrode scanning circuit.

The invention has been made to solve the above problems of conventional art, and an advantage of the invention is to be able to provide a technique which realizes low power consumption when controlling display/non-display of an arbitrary area in the display device.

The above and the other advantages and the novel characteristics of the invention will be clarified in description of the specification and the attached drawings.

Outlines of typical inventions in inventions disclosed in the present application will be explained as follows.

(1) A display device includes a display panel having a plurality of pixels, a plurality of scanning lines which apply scanning voltages to the plurality of pixels, and a plurality of signal lines formed along the extending direction of the plurality of scanning lines, which apply prescribed voltages to the plurality of pixels; and a drive circuit which drives the display panel, and the drive circuit has shift register circuits which sequentially output a first to the order of “n” (n≧2) shift pulses at each prescribed period based on transfer clocks to be inputted, “n” pieces of first transistors in which the first to the order of “n” shift pulses outputted from the shift resister circuits are inputted to gates respectively, and “n” pieces of signal line scanning circuits, and the respective first transistors perform sampling of scanning line drive clocks and output them as the scanning voltages for a first to the order of “n” scanning lines based on the first to the order of “n” shift pulses outputted from the shift resistor circuits, and the respective signal line scanning circuits output the prescribed voltages for a first to the order of “n” signal lines based on the first to the order of “n” shift pulses outputted from the shift register circuits, an alternation signal, an inverting alternation signal and the transfer clocks.

(2) In (1), the order of “k” (1≦k≦n) signal line scanning circuit selects the prescribed voltage for the order of “k” signal line based on the order of (k−1) shift pulse outputted from the shift register circuit, the alternation signal, the inverting alternation signal and the transfer clock, and outputs the selected voltage based on the order of “k” shift pulse outputted from the shift register circuit and the transfer clock.

(3) In (1) or (2), the display device further includes “n” pieces of second transistors in which the first to the order of “n” shift pulses outputted from the shift resister circuits are inputted to gates respectively, and “n” pieces of third transistors and fourth transistors provided at respective signal line scanning circuits, and the order of “k” second transistor performs sampling of the transfer clock and inputs it as an enable signal to the order of “k” signal line scanning circuit based on the shift pulse outputted from the order of “k” shift resistor circuit, the order of “k” third transistor performs sampling of the alternation signal and inputs it to the order of “k” signal line scanning circuit based on the transfer clock sampled by the order of (k−1) second transistor, and the order of “k” fourth transistor performs sampling of the inverting alternation signal and inputs it to the order of “k” signal line scanning circuit based on the transfer clock sampled by the order of (k−1) second transistor.

(4) In (3), the transfer clocks are a first transfer clock and a second transfer clock having the same cycle and different phases, and one of the two adjacent second transistors perform sampling of the first transfer clock and the other of the two adjacent second transistors performs sampling of the second transfer clock.

(5) In any of (1) to (4), the scanning line drive clocks are a first scanning line drive clock and a second scanning line drive clock having the same cycle and different phases, and one of the two adjacent first transistors performs sampling of the first scanning line drive clock and the other of the two adjacent first transistors performs sampling of the second scanning line drive clock.

(6) A display device includes a display panel having a plurality of pixels, a plurality of scanning lines which apply scanning voltages to the plurality of pixels, and a plurality of signal lines formed along the extending direction of the plurality of scanning lines, which apply prescribed voltages to the plurality of pixels; and a drive circuit which drives the display panel, and the drive circuit has shift register circuits which sequentially output a first to the order of “n” (n≧2) shift pulses at each prescribed period based on transfer clocks to be inputted, “n” pieces of first to the order of “j” (j≧2) transistors in which the first to the order of “n” shift pulses outputted from the shift resister circuits are inputted to gates respectively, and “j×n” pieces of signal line scanning circuits, and the respective first to the order of “j” transistors perform sampling of a first to the order of “j” scanning line drive clocks respectively and output them as the scanning voltages for a first to the order of “j×n” scanning lines based on the first to the order of “n” shift pulses outputted from the shift resistor circuits, and the respective signal line scanning circuits output the prescribed voltages for a first to the order of “j×n” signal lines based on the first to the order of “n” shift pulses outputted from the shift resister circuits, an alternation signal, an inverting alternation signal and the transfer clocks.

(7) In any of (1) to (6), the scanning line drive clocks have off-periods fixed at a first voltage level or at a second voltage level within one frame period.

(8) A display device includes a display panel having a plurality of pixels, a plurality of scanning lines which apply scanning voltages to the plurality of pixels, and a plurality of signal lines formed along the extending direction of the plurality of scanning lines, which apply prescribed voltages to the plurality of pixels; and a drive circuit which drives the display panel, and the drive circuit has shift register circuits which sequentially output a first to the order of “n” (n≧2) shift pulses at each prescribed period based on transfer clocks to be inputted, “n” pieces of first transistors and second transistors in which the first to the order of “n” shift pulses outputted from the shift resister circuits are inputted to gates respectively, and “2n” pieces of signal line scanning circuits, and the order of “k” (1≦k≦n) first transistor performs sampling of a first scanning line drive clock and output it as the scanning voltage for the order of a (2k−1) scanning line based on the order of “k” shift pulse outputted from the shift resistor circuit, and the order of “k” second transistor performs sampling of a second scanning line drive clock which has the same cycle as, and different phases from the first scanning line drive clock and outputs it as the scanning voltage for the order of “2k” scanning line based on the order of “k” shift pulse outputted from the shift register circuit, and the order of (2k−1) and the order of “2k” signal line scanning circuits output the prescribed voltages for the order of (2k−1) and the order of “2k” signal lines based on the order of (k−1) and the order of “k” shift pulses outputted from the shift register circuits, an alternation signal, an inverting alternation signal and the transfer clocks.

(9) In (8), the order of (2k−1) and the order of “2k” signal line scanning circuit select the prescribed voltages for the order of (2k−1) and the order of “2k” signal lines based on the order of (k−1) shift pulse outputted from the shift register circuit, the alternation signal, the inverting alternation signal and the transfer clocks, and output the selected voltages based on the order of “k” shift pulse outputted from the shift register and the transfer clocks.

(10) In (8) or (9), the display device includes “n” pieces of third transistors in which the first to the order of “n” shift pulses outputted from the shift register circuits are applied to gates respectively, and “2n” pieces of fourth transistors and fifth transistors provided at respective signal line scanning circuits, and the order of “k” third transistor performs sampling of the transfer clocks and inputs them to the order of (2k−1) and the order of “2k” signal line scanning circuits as enable signals based on the order of “k” shift pulse outputted from the shift resistor circuit, the order of (2k−1) fourth transistor performs sampling of the alternation signal and inputs it to the order of (2k−1) signal scanning circuit based on the transfer clock sampled in the order of (k−1) third transistor, the order of (2k−1) fifth transistor performs sampling of the inverting alternation signal and inputs it to the order of (2k−1) signal line scanning circuit based on the transfer clock sampled in the (k−1) third transistor, the order of “2k” fourth transistor performs sampling of the alternation signal and inputs it to the order of “2k” signal line scanning circuit based on the transfer clock sampled in the (k−1) third transistor, and the order of “2k” fifth transistor performs sampling of the inverting alternation signal and inputs it to the order of “2k” signal line scanning circuit based on the transfer clock sampled in the (k−1) third transistor.

(11) In (10), the transfer clocks are a first transfer clock and a second transfer clock having the same cycle and different phases, and one of the two adjacent third transistors performs sampling of the first transfer clock and the other of the two adjacent third transistors performs sampling the second transfer clock.

(12) A display device includes a display panel having a plurality of pixels, a plurality of scanning lines which apply scanning voltages to the plurality of pixels, and a plurality of signal lines formed along the extending direction of the plurality of scanning lines, which apply prescribed voltages to the plurality of pixels; and a drive circuit which drives the display panel, and the drive circuit has shift register circuits which sequentially output a first to the order of “n” (n≧2) shift pulses at each prescribed period based on transfer clocks to be inputted, “n” pieces of first transistors and second transistors in which the first to the order of “n” shift pulses outputted from the shift resister circuits are inputted to gates respectively, and “2n” pieces of signal line scanning circuits, and the order of “k” (1≦k≦n) first transistor performs sampling of a first scanning line drive clock and output it as the scanning voltage for the order of a (2k−1) scanning line based on the order of “k” shift pulse outputted from the shift resistor circuit, and the order of “k” second transistor performs sampling of a second scanning line drive clock which has the same cycle as, and a different phase from the first scanning line drive clock and outputs it as the scanning voltage for the order of “2k” scanning line based on the order of “k” shift pulse outputted from the shift register circuit, and the order of (2k−1) and the order of “2k” signal line scanning circuits output the prescribed voltages for the order of (2k−1) and the order of “2k” signal lines based on the order of (k−1) and the order of “k” shift pulses outputted from the shift register circuits, an alternation signal, an inverting alternation signal, a first signal line drive clock and a second signal line drive clock which has the same cycle as, and a different phase from the first signal line drive clock.

(13) In (12), the (2k−1) signal line scanning circuit selects the prescribed voltage for the order of (2k−1) signal line based on the order of (k−1) shift pulse outputted from the shift register circuit, the alternation signal, the inverting alternation signal and the second signal line drive clock, and outputs the selected voltage based on the order of “k” shift pulse outputted from the shift resister circuit and the first signal line drive clock, and the order of “2k” signal line scanning circuit selects the prescribed voltage for the order of “2k” signal line based on the order of “k” shift pulse outputted from the shift resister circuit, the alternation signal, the inverting alternation signal and the first signal line drive clock, and outputs the selected voltage based on the order of “k” shift pulse outputted from the shift resister circuit and the second signal line drive clock.

(14) In (12) or (13), the display device includes “n” pieces of third transistors and forth transistors in which the first to the order of “n” shift pulses outputted from the shift resister circuits are applied to gates respectively, and “2n” pieces of fifth transistors and the sixth transistors provided at respective “2n” pieces of signal line scanning circuits, and the order of “k” third transistor performs sampling of the first signal line drive clock and inputs it to the order of (2k−1) signal line scanning circuit as an enable signal based on the order of “k” shift pulse outputted from the shift resister circuit, the order of “k” fourth transistor performs sampling of the second signal line drive clock and inputs it to the order of “2k” signal line scanning circuit as an enable signal based on the order of “k” shift pulse outputted from the shift resister circuit, the order of (2k−1) fifth transistor performs sampling of the alternation signal and inputs it to the order of (2k−1) signal line scanning circuit based on the second signal line drive clock sampled in the order of (k−1) fourth transistor, the order of (2k−1) sixth transistor performs sampling of the inverting alternation signal and inputs it to the (2k−1) signal line scanning circuit based on the second signal line drive clock sampled in the order of (k−1) fourth transistor, the order of “2k” fifth transistor performs sampling of the alternation signal and inputs it to the order of “2k” signal line scanning circuit based on the first signal line drive clock sampled in the order of “k” third transistor, and the order of “2k” sixth transistor performs sampling of the inverting alternation signal and inputs it to the order of “2k” signal line scanning circuit based on the first signal line drive clock sampled at the order of “k” third transistor.

(15) In any of (8) to (14), the first and second scanning line drive clocks have off-periods fixed at a first voltage level or at a second voltage level in one frame period.

(16) A display device includes a display panel having a plurality of pixels, a plurality of scanning lines which apply scanning voltages to the plurality of pixels, and a plurality of signal lines formed along the extending direction of the plurality of scanning lines, which apply prescribed voltages to the plurality of pixels; and a drive circuit which drives the display panel, and the drive circuit has shift register circuits which sequentially output a first to the order of “n” (n≧2) shift pulses at each prescribed period based on transfer clocks to be inputted, “n” pieces of first transistors and second transistors in which the first to the order of “n” shift pulses outputted from the shift resister circuits are inputted to gates respectively, “n” pieces of third transistors and fourth transistors in which a selection signal is applied to gates respectively, “n” pieces of fifth transistors and sixth transistors in which an inverting selection signal is applied to gates respectively, and “2n” pieces of signal line scanning circuits, and the order of “k” (1≦k≦n) first transistor performs sampling of a first scanning line drive clock and output it as the scanning voltage for the order of (2k−1) scanning line based on the order of “k” shift pulse outputted from the shift resistor circuit, and the order of “k” second transistor performs sampling of a second scanning line drive clock which has the same cycle as, and a different phase from the first scanning line drive clock and outputs it as the scanning voltage for the order of “2k” scanning line based on the order of “k” shift pulse outputted from the shift register circuit, the order of “k” third transistor inputs the first scanning line drive clock sampled in the order of “k” first transistor to the order of (2k−1) signal line scanning circuit as an enable signal based on the selection signal, the order of “k” fourth transistor inputs the second scanning line drive clock sampled in the order of “k” second transistor to the order of “2k” signal line scanning circuit as an enable signal based on the selection signal, the order of “k” fifth transistor inputs the order of “k” shift pulse outputted from the shift register circuit to the order of (2k−1) signal line scanning circuit as an enable signal based on the inverting selection signal, the order of “k” sixth transistor inputs the order of “k” shift pulse outputted from the shift register circuit to the order of “2k” signal line scanning circuit as an enable signal based on the inverting selection signal, and the order of (2k−1) and the order of “2k” signal line scanning circuits output the prescribed voltages for the order of (2k−1) and the order of “2k” signal lines based on the order of (k−1) and the order of “k” shift pulses outputted from the shift register circuits, a first alternation signal, an inverting first alternation signal, a second alternation signal, an inverting second alternation signal and the first and second scanning line drive clocks.

(17) In (16), the order of (2k−1) signal line scanning circuit selects the prescribed voltage for the order of (2k−1) signal line based on the shift pulse outputted from the order of (k−1) shift register circuit, the first alternation signal and the inverting first alternation signal and outputs the selected voltage based on the first scanning line drive clock or the order of “k” shift pulse outputted from the shift register circuit, and the order of “2k” signal line scanning circuit selects the prescribed voltage for the order of “2k” signal line based on the shift pulse outputted from the order of (k−1) shift register circuit, the second alternation signal and the inverting second alternation signal, and outputs the selected voltage based on the second scanning line drive clock or the order of “k” shift pulse outputted from the shift register circuit.

(18) In (16) or (17), the display device includes “2n” pieces of seventh transistors and eighth transistors provided at respective “2n” pieces of signal line scanning circuits, and the order of (2k−1) seventh transistor performs sampling of the first alternation signal and inputs it to the order of (2k−1) signal line scanning circuit based on the order of (k−1) shift pulse outputted from the shift register circuit, the order of (2k−1) eighth transistor performs sampling of the inverting first alternation signal and inputs it to the order of (2k−1) signal line scanning circuit based on the order of (k−1) shift pulse outputted from the shift register circuit, the order of “2k” seventh transistor performs sampling of the second alternation signal and inputs it to the order of “2k” signal line scanning circuit based on the order of (k−1) shift pulse outputted from the shift register circuit, and the order of “2k” eighth transistor performs sampling of the inverting second alternation signal and inputs it to the order of “2k” signal line scanning circuit based on the order of (k−1) shift pulse outputted from the shift register circuit.

(19) In (18), the transfer clocks are a first transfer clock and a second transfer clock having the same cycle and different phases.

(20) In any of (16) to (19), the first and second scanning line drive clocks have off-periods fixed at a first voltage level or at a second voltage level in one frame period.

(21) In (20), during the off-period of the first and second scanning line drive clocks, the selection signal is at a third voltage level, the inverting selection signal is at a fourth voltage level, and during periods other than the off-period of the first and second scanning line drive clocks, the selection signal is at the fourth voltage level and the inverting selection signal is at the third voltage level.

(22) In (20) or (21), during the off-period of the first and second scanning line drive clocks, the first alternation signal and the second alternation signal have the same phase.

(23) In any of (16) to (22), during a normal display period, the first alternation signal and the second alternation signal have opposite phases, and during a partial display period, the first alternation signal and the second alternation signal have the same phase.

(24) In any of (7), (15), (20) to (23), an amplitude level of the transfer clocks during the off-period is lower than an amplitude level of the transfer clocks during periods other than the off-period.

(25) In any of (1) to (24), the signal line is a counter electrode line, and the prescribed voltages are a counter voltage at a first voltage level and a counter voltage at a second voltage level.

(26) In any of (1) to (24), the signal line is a compensation signal line applying a compensation voltage to each pixel.

An advantage obtained by the typical invention in inventions disclose in the application will be explained as follows.

According to the display device of the invention, when controlling display and non-display of the arbitrary regions, low power consumption is possible.

### BRIEF DESCRIPTION OF THE DRAWINGS

FIG. 1 is a block diagram showing a schematic configuration of a scanning line drive circuit according to an embodiment 1 of the invention.

FIG. 2 is a view showing a timing chart in one frame at the time of a partial display drive in the scanning line drive circuit shown in FIG. 1.

FIG. 3 is a view showing a timing chart of a normal display drive and five frames of the partial display drive in the scanning line drive circuit shown in FIG. 1.

FIG. 4 is a view showing a timing chart in one frame at the time of the partial display drive in a modification example of the scanning line drive circuit shown in FIG. 1.

FIG. 5 is a block diagram showing a schematic configuration of a scanning line drive circuit of an embodiment 2 of the invention.

FIG. 6 is a view showing a timing chart in one frame at the time of partial display drive in the scanning line drive circuit shown in FIG. 5.

FIG. 7 is a view showing a timing chart of the normal display drive and five frames of partial display drive in the scanning line drive circuit shown in FIG. 5.

FIG. 8 is a block diagram showing a schematic configuration of a scanning line drive circuit of an embodiment 3 of the invention.

FIG. 9 is a view showing a timing chart in one frame at the time of partial display drive in the scanning line drive circuit shown in FIG. 8.

FIG. 10 is a view showing a timing chart of the normal display drive and five frames of partial display drive in the scanning line driving circuit shown in FIG. 8.

FIG. 11 is a block diagram showing a schematic configuration of a scanning line drive circuit of an embodiment 4 of the invention.

FIG. 12 is a view showing a timing chart in one frame at the time of partial display drive in the scanning line drive circuit shown in FIG. 11.

FIG. 13 is a view showing a timing chart of the normal display period and five frames of partial display drive in the scanning line drive circuit shown in FIG. 11.

FIG. 14 is a circuit diagram showing an equivalent circuit of a subpixel of an independent charge-coupling driving liquid crystal display panel.

FIG. 15 is a block diagram showing a schematic configuration of a scanning line driving circuit driving a conventional independent charge-coupling driving liquid crystal display panel.

FIG. 16 is a view showing a timing chart of the scanning line drive circuit shown in FIG. 15.

FIG. 17 is a view showing a standby screen in a cellular phone.

FIG. 18A to FIG. 18D are views explaining a partial display drive and alternation of liquid crystal in a liquid crystal display device.

FIG. 19 is a block diagram showing a schematic configuration of a conventional IPS liquid crystal display panel and a scanning line drive circuit.

FIG. 20 is a view showing an equivalent circuit of a subpixel of the liquid crystal display panel shown in FIG. 19.

FIG. 21A to FIG. 21B are views showing timing charts of the scanning line drive circuit shown in FIG. 19.

### DESCRIPTION OF THE PREFERRED EMBODIMENTS

Hereinafter, embodiments of the invention will be explained in detail with respect to the drawings.

In all drawings for explaining the embodiments, the same signs are put to components having the same functions and repeated explanations thereof will be omitted.

### Embodiment 1

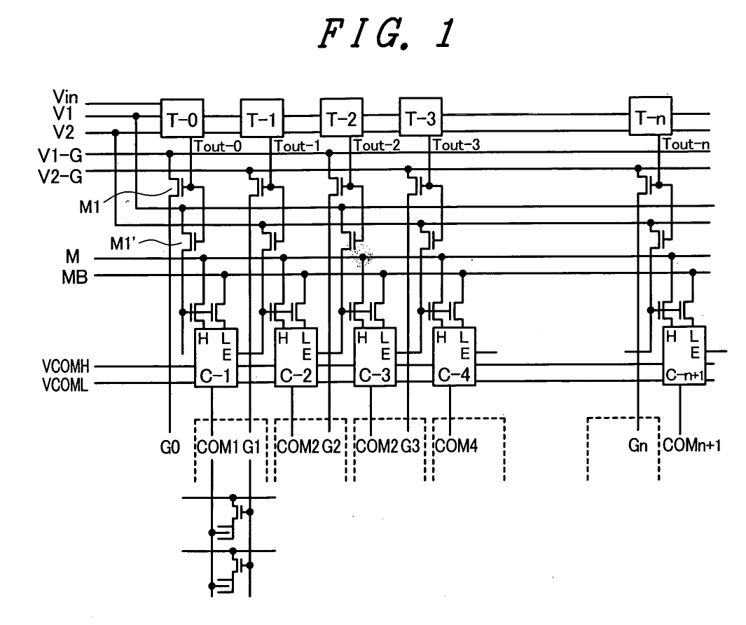

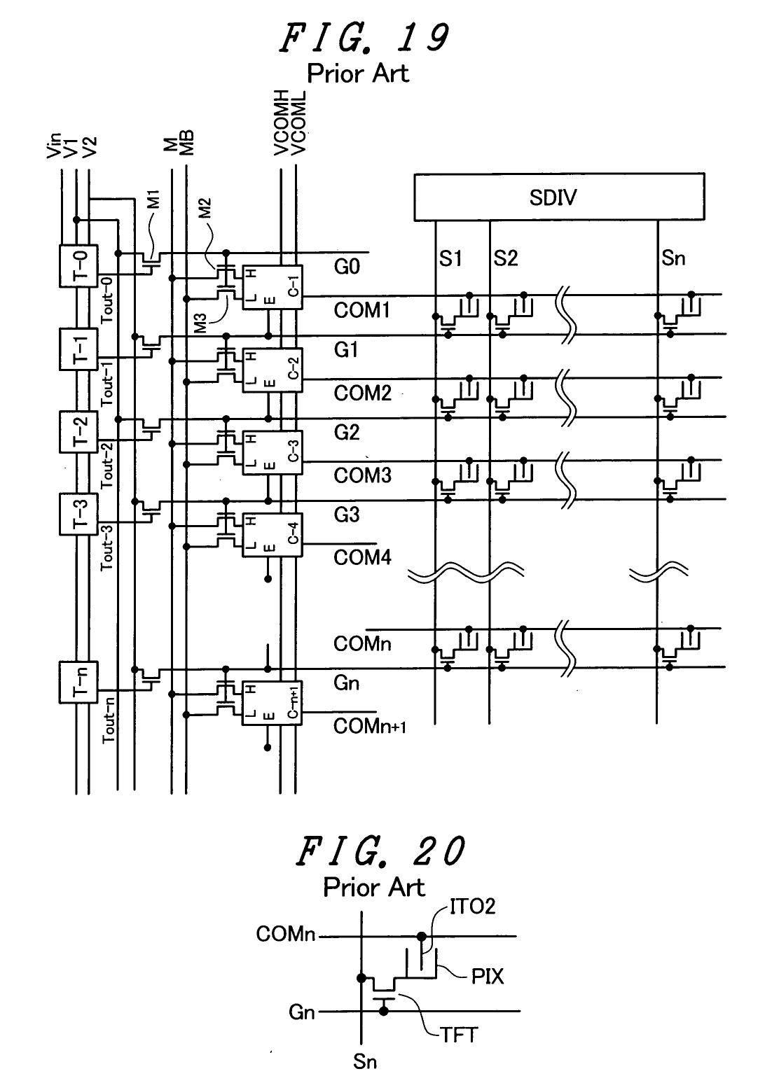

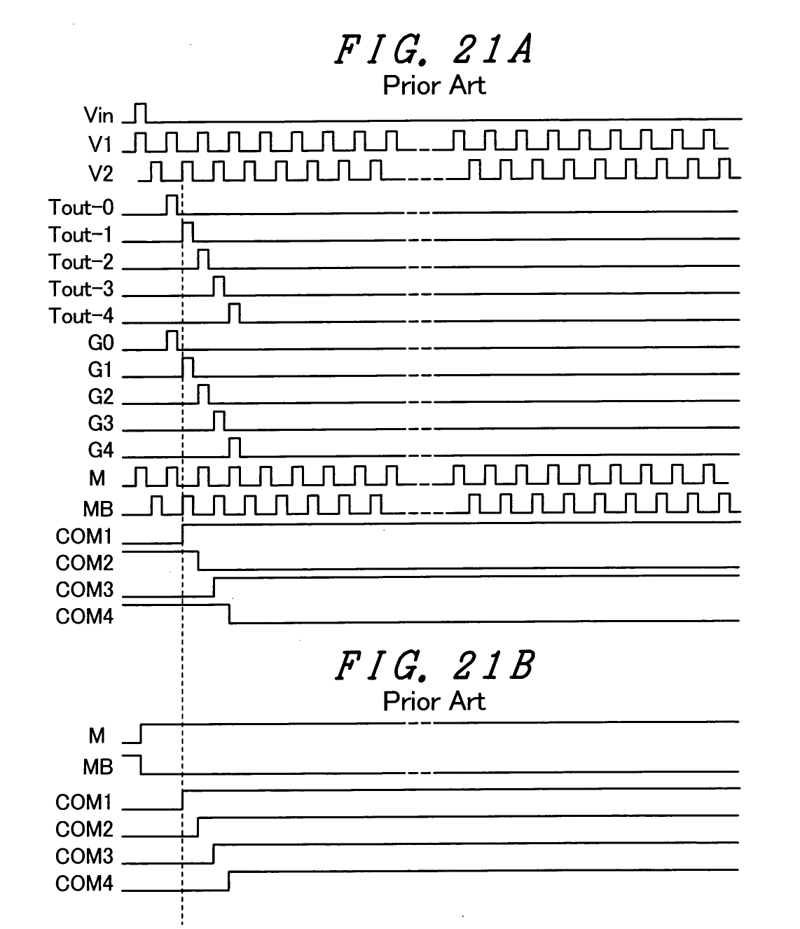

FIG. 1 is a block diagram showing a schematic configuration of a scanning line drive circuit of an embodiment 1 of the invention. The embodiment is a circuit which drives scanning lines (Gn) and counter electrode lines (COM1 to COMn+1) in an IPS liquid crystal display panel in the same way as FIG. 19.

The embodiment is the circuit in which scanning line drive clocks (V1-G, V2-G) and transistors M1′ are newly added to the scanning line drive circuit shown in FIG. 19.

In the scanning line drive circuit shown in FIG. 19, the scanning lines (G0 to Gn) of respective stages are driven by applying shift pulses (Tout-0 to Tout-n) to gates of transistors (M1) and applying transfer clocks (V1, V2) to drains of transistors (M1).

On the other hand, new transistors (M1′) are provided in the embodiment, and scanning lines (G0 to Gn) of respective stages are driven by applying shift pulses (Tout-0 to Tout-n) to gates of transistors (M1) and applying scanning line drive clocks (V1-G, V2-G) to drains of transistors (M1).

Counter electrode scanning circuits (C-1 to C-n+1) (a signal line scanning circuits of the invention) use the transfer clocks (V1, V2) as operation signals for the counter electrode scanning circuits in the same way as the scanning line drive circuit shown in FIG. 19.

For example, the counter electrode scanning circuit (C-1) determines which of an H-level common voltage (VCOMH) or an L-level common voltage (VCOML) is outputted based on the transfer clock (V1), an alternation signal (M) and an inverting alternation signal (MB), and outputs either the H-level common voltage (VCOMH) or the L-level common voltage (VCOML) to the counter electrode line (COM1 to COMn+1) by inputting the transfer clock (V2) as an enable signal (E).

Accordingly, in the embodiment, the scanning line drive clocks (V1-G, V2-G) are outputted as selection scanning voltages for the scanning lines (G0 to Gn) through the transistors (M1) in which the shift pulses (Tout-0 to Tout-n) are inputted to gates thereof, and transfer clocks (V1, V2) are outputted to the counter electrode lines (COM1 to COMn+1) through the transistors (M1′) in which shift pulses (Tout-0 to Tout-n) are inputted to gates thereof.

In the embodiment, clocks are separated, namely, the transfer clocks (V1, V2) are used for controlling shift register circuits (T-0 to T-n) and counter electrode scanning circuits (C-1 to C-n+1), and the scanning line drive clocks (V1-G, V2-G) are used for outputting the scanning voltage to the scanning lines (G0 to Gn).

Therefore, it becomes possible that gate scanning is not performed in black parts at frames of FIG. 18B and FIG. 18C (that is, to output a non-selection scanning voltage to the scanning lines), which was difficult in the scanning line drive circuit shown in FIG. 19.

In FIG. 1, the shift register circuit (T-0) is provided for inputting the alternation signal (M) and the inverting alternation signal (MB) to the counter electrode scanning circuit (C-1).

Therefore, if the alternation signal (M) and the inverting alternation signal (MB) can be inputted to the counter electrode scanning circuit (C-1) at the same timing as the shift pulse (Tout-0) is outputted, after a start pulse (Vin) is inputted, the shift register circuit (T-0) and the transistor (M1′) in which the shift pulse (Tout-0) is inputted to the gate are not necessary.

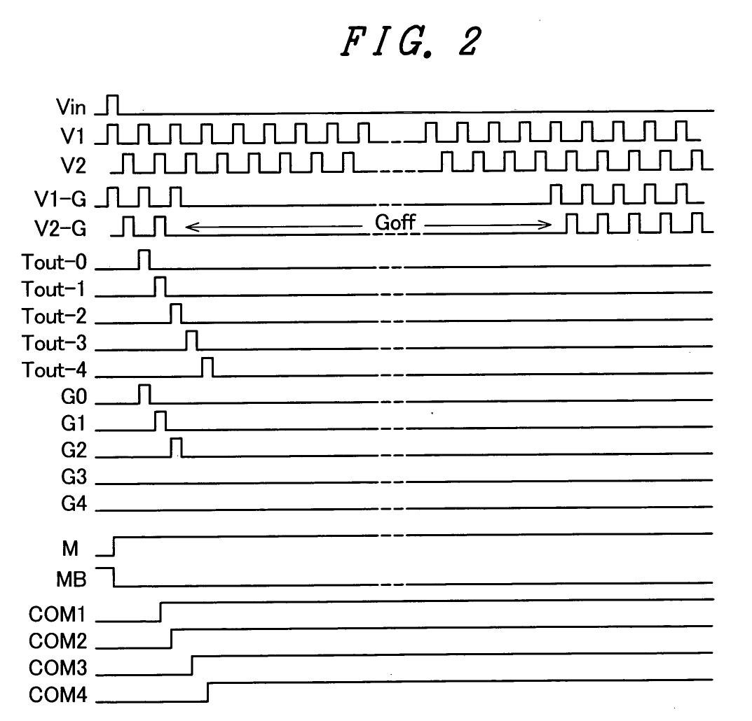

FIG. 2 is a view showing a timing chart in one frame at the time of partial display drive in the scanning line drive circuit shown in FIG. 1.

As shown in FIG. 2, the scanning line drive clocks (V1-G, V2-G) are fixed at the L-level during a period when gate scanning is not performed (Goff in FIG. 2) and a non-selection scanning voltage is outputted to the scanning lines (G3, G4 in FIG. 2) during the period. The alternation signal (M) and the inverting alternation signal (MB) have a frame inversion drive wavelength.

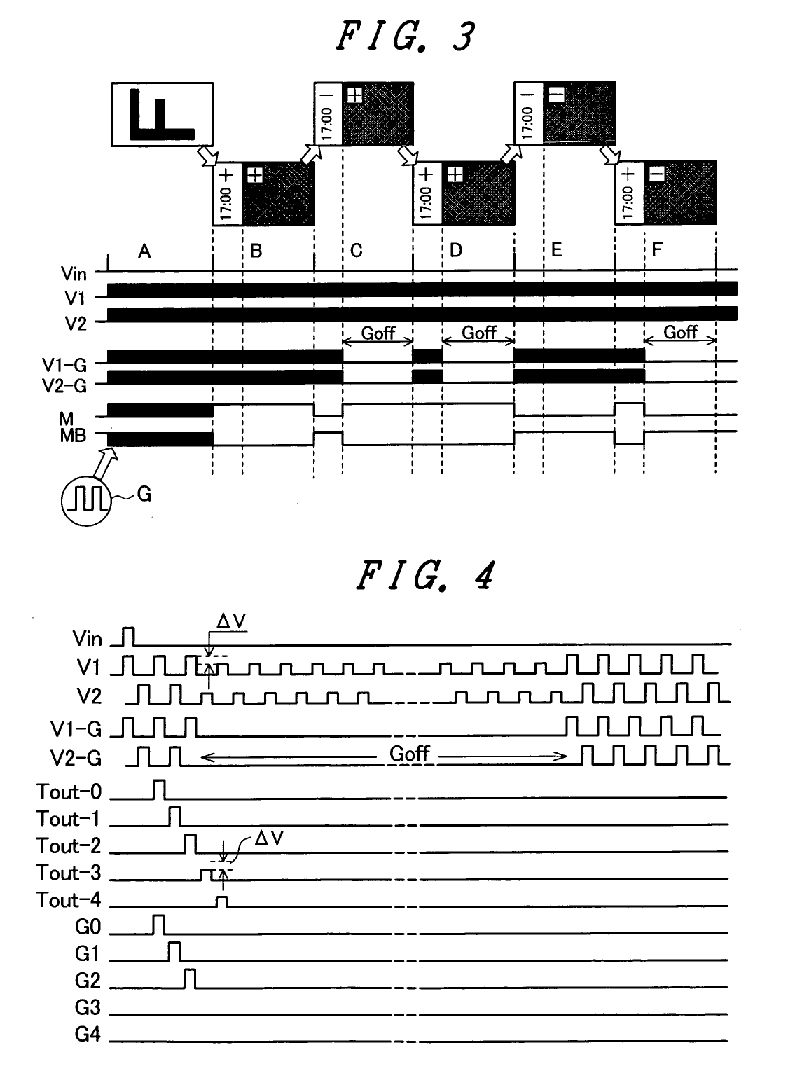

FIG. 3 is a view showing a timing chart of a normal display drive and five frames of the partial display drive in the scanning line drive circuit shown in FIG. 1.

In FIG. 3, “A” denotes the normal display period, and the normal display period “A” is a line inversion period as shown by a waveform of “G”.

“B” to “F” denote partial display periods, where there are periods when the scanning line drive clocks (V1-G, V2-G) are fixed at the L-level and gate scanning is not performed (Goff periods in FIG. 3) in second and third partial frames (C, D).

Furthermore, in the partial display periods (“B” to “F”), the alternation signal (M) and the inverting alternation signal (MB) are controlled to be a frame inversion drive. Power saving can be achieved by the Goff period and the effects of the frame inversion.

FIG. 4 is a view showing a timing chart in one frame at the time of the partial display drive in a modification example of the scanning line drive circuit shown in FIG. 1.

In the example shown in FIG. 4, voltages of the transfer clocks (V1, V2) in the Goff period are reduced by ΔV.

By reducing voltages of the transfer clocks (V1, V2), the gate voltages of transistors (M1, M1′) of FIG. 1 are reduced, as a result, on-resistance of transistors increases. However, during the Goff period, the drain side (the side to which the clock of V1 is supplied) of the transistors (M1) has the L-level potential, therefore, the low gate voltage does not matter.

In addition, even when the gate voltage of the transistors (M1′) is reduced, input load of the counter electrode scanning circuit (C-1 to C-n+1) is extremely low as compared to the scanning line (usually, more than 100:1), the increase of on-resistance of transistor caused by reduction of gate voltage does not matter.

To reduce voltages of the transfer clocks during the Goff period can be applied to all embodiment described later, and the low voltage effect enables further power saving.

### Embodiment 2

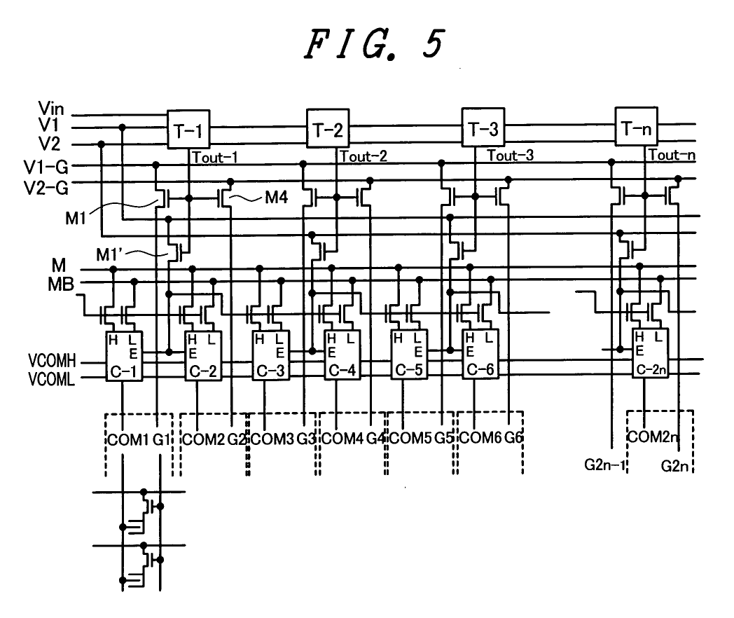

FIG. 5 is a block diagram showing a schematic configuration of a scanning line drive circuit of an embodiment 2 of the invention.

The embodiment is the circuit in which the number of blocks of shift register circuits (T-1 to T-n) is reduced and transistors (M4) are added to the above embodiment.

As shown in FIG. 5, shift pulses (Tout-1 to Tout-n) as outputs of the shift resistor circuits (T-1 to T-n) are applied to gates of transistors (M1) for driving scanning lines, and applied to gates of the newly added transistors (M4).

The transistors (M1) in which a scanning line drive clock (V1-G) is applied to drains thereof drive scanning lines (for example, a scanning line G1) (that is, a selection scanning voltage is outputted to the scanning line (G1), and the transistors (M4) in which a scanning line drive clock (V2-G) is applied to drains thereof drive the scanning lines (for example, a scanning line G2).

That is, in the embodiment, the shift resister circuit (T-1 to T-n) drives two scanning lines by one stage of each block. As a result, a transfer cycle of the shift resister circuits (T-1 to T-n) becomes half of the gate drive cycle.

This means that the frequency of transfer clocks (V1, V2) becomes half of the frequency of the scanning line drive clocks (V1-G, V2-G) for gate driving, accordingly, the transfer clocks (V1, V2) can be low in frequency and low in power consumption.

In addition, transistors (M1′) in which the shift pulses (Tout-1 to Tout-n) are applied to gates thereof input the transfer clocks (V1, V2) which are applied to drains thereof to the counter electrode scanning circuits (C-1 to C-2n).

The signals determine the H-level common voltage (VCOMH) or the L-level common voltage (VCOML) and are used as enable signals.

Since the transfer clocks (V1, V2) are inputted in respective two adjacent stages of counter electrode scanning circuits through the same transistor (M1′), the respective two adjacent stages of counter electrode scanning circuits select the common voltage having the same polarity, and perform output simultaneously.

The voltage polarity supplied to the counter electrodes (ITO2) can not be inverted by one line, therefore, the alternation signal (M) and the inverting alternation signal (MB) are switched at every two-horizontal periods to perform two-line inversion drive in the normal display period, and they are switched at every one vertical period to perform the frame inversion in the partial display period.

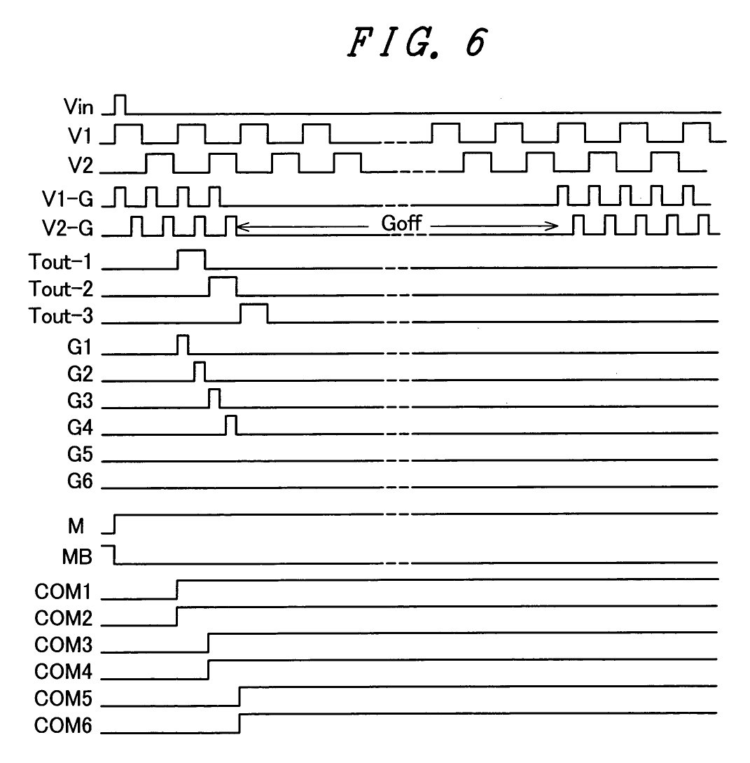

FIG. 6 is a view showing a timing chart in one frame at the time of partial display drive in the scanning line drive circuit shown in FIG. 5.

In the same way as the above embodiment, the scanning line drive clocks (V1-G, V2-G) are fixed at the L-level during a period when gate scanning is not performed (Goff period). The alternation signal (M) and the inverting alternation signal (MB) have waveforms to be the frame inversion drive.

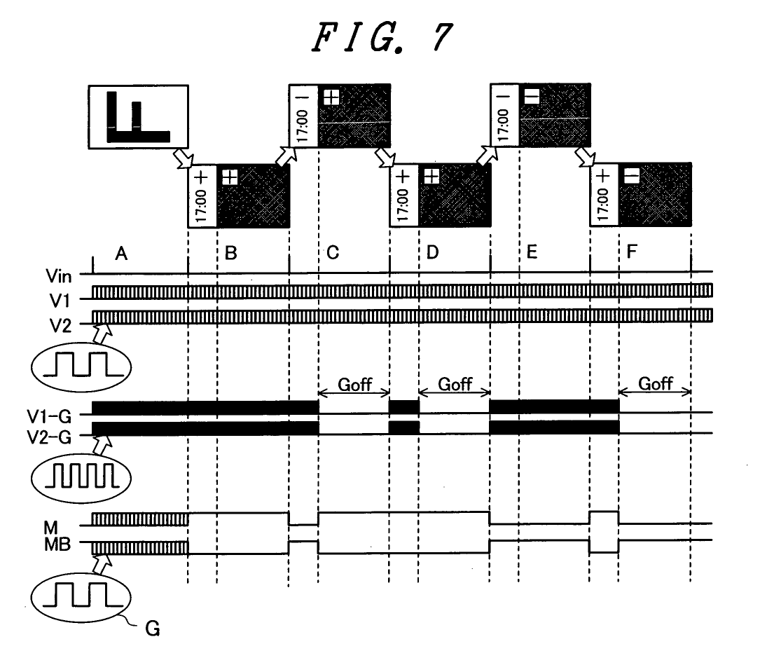

FIG. 7 is a view showing a timing chart of the normal display drive and five frames of partial display drive in the scanning line drive circuit shown in FIG. 5. FIG. 7 is the same as the above FIG. 3 except that the transfer clocks (V1, V2), the alternation signal (M) and the inverting alternation signal (MB) operate at a half of the frequency of the scanning line drive clocks (V1-G, V2-G).

Specifically, in FIG. 7, “A” is a normal display period, which is a line inversion period (two-line inversion) as denoted by a waveform “G”. “B” to “F” are partial display periods, where there are periods when the scanning line drive clocks (V1-G, V2-G) are fixed at the L-level and gate scanning is not performed (namely, periods when a non-selection scanning voltage is outputted to scanning lines: Goff periods in FIG. 7) in second and third partial frames (C, D).

In the embodiment, the example in which two scanning lines are driven with respect to one stage of the shift register circuit (T-1 to T-n), however, it is possible to increase the number of scanning lines to be driven to arbitrary plural numbers by further reducing the frequency of the transfer clocks (V1, V2). Accordingly, further power consumption saving can be achieved.

### Embodiment 3

FIG. 8 is a block diagram showing a schematic configuration of a scanning line drive circuit of an embodiment 3 of the invention.

The embodiment has a circuit configuration in which common electrode drive clocks (V1-C, V2-C) (signal line drive clocks of the invention) and transistors (M4′) are newly added to the above embodiments. The method of driving gates is the same as the above embodiments.

The transistors (M1′) in which shift pulses (Tout-1 to Tout-n) are applied to gates thereof use the common control clock (V1-C) applied to drains thereof for determination of polarity of a common voltage of every other counter electrode scanning circuit (C-2, C-4, C-6, . . . ), and use them as enable signals for every other counter electrode scanning circuit (C-1, C-3, C-5, . . . ).

The transistors (M4′) in which shift pulses (Tout-1 to Tout-n) are applied to gates thereof use the common control clock (V2-C) applied to drains thereof for determination of polarity of a common voltage of every other counter electrode scanning circuit (C-1, C-3, C-5, . . . ), and use them as enable signals for every other counter electrode scanning circuit (C-2, C-4, C-6, . . . ).

Accordingly, signals inputted to the counter electrode scanning circuits (C-1 to C-2n) are independent in respective blocks of the counter electrode scanning circuits, and determination of the H-level common voltage (VCOMH) or the L-level common voltage (VCOML) and output are performed independently by one stage.

Therefore, the method of alternation is different from the two-line inversion drive in the above embodiment, and can be one-line inversion drive during the normal display period and the frame inversion drive during the partial display period, which is the same as the embodiment 1. Accordingly, image deterioration concerned in the two-line inversion drive can be avoided.

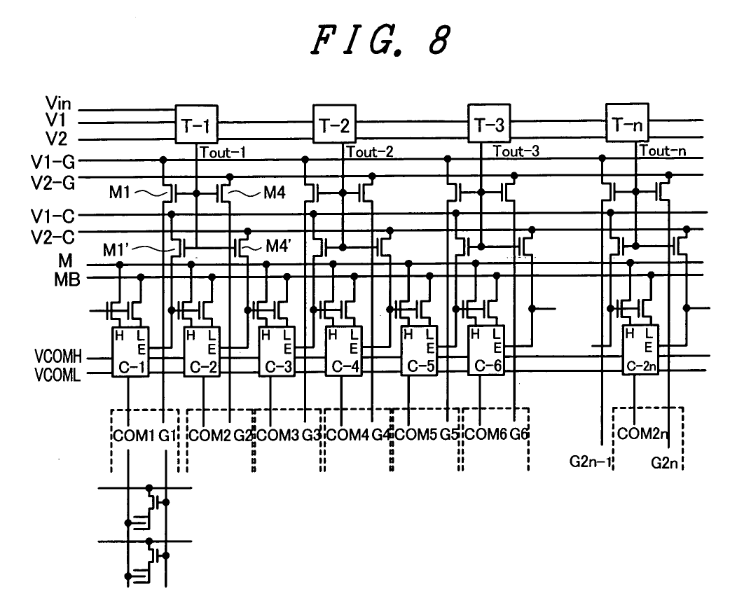

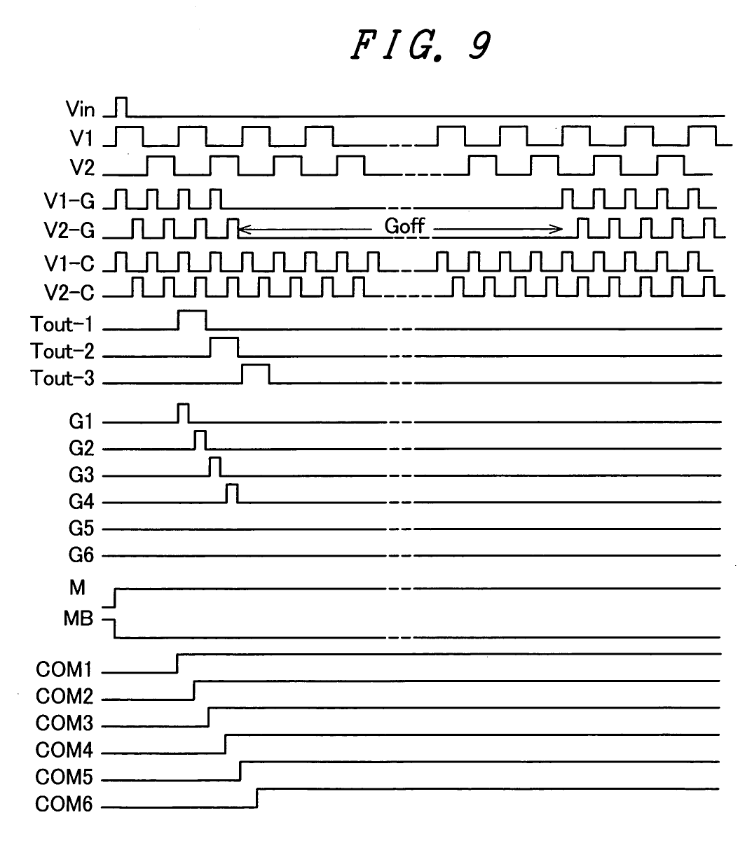

FIG. 9 is a view showing a timing chart in one frame at the time of partial display drive in the scanning line drive circuit shown in FIG. 8.

The difference from the timing chart shown in FIG. 6 is that the common voltage applied to the counter electrode lines (COMn) is sequentially outputted by one stage.

The common control clocks (V1-C, V2-C) are signals which drives at the same frequency as the scanning line drive clocks (V1-G, V2-G), and keep outputting even during the period when gate scanning is not performed (Goff period).

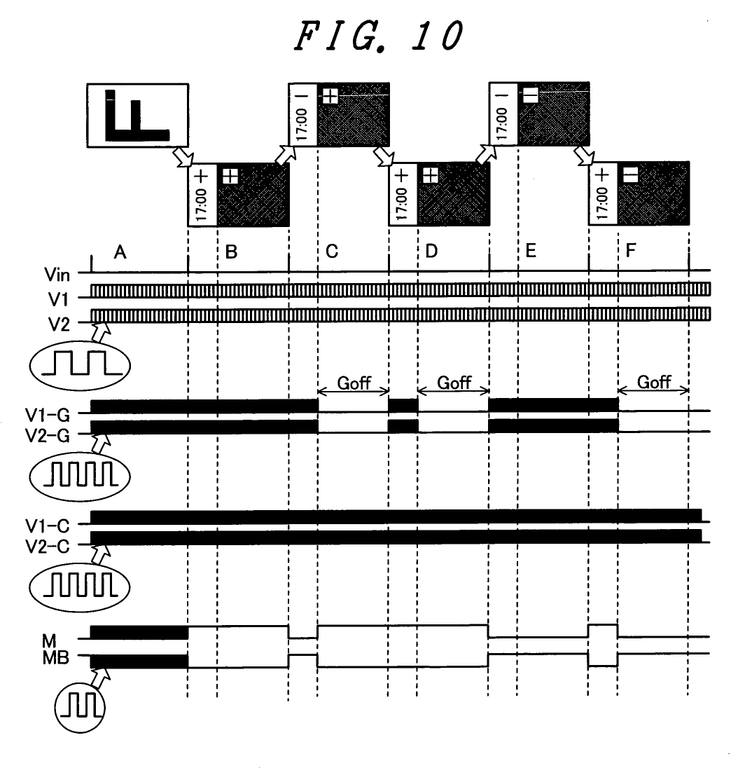

FIG. 10 is a view showing a timing chart of the normal display drive and five frames of partial display drive in the scanning line driving circuit shown in FIG. 8.

In FIG. 10, “A” is the normal display period, which is the line inversion period (one line inversion). “B” to “F” are partial display periods, where there are periods when the scanning line drive clocks (V1-G, V2-G) are fixed at the L-level and gate scanning is not performed (namely, Goff periods in FIG. 10) in the second and third partial frames (C, D).

In FIG. 10, the alternation signal (M) and the inverting alternation signal (MB) are switched at each one horizontal period to perform the line inversion during the normal display period “A”, and the alternation signal (M) and the inverting alternation signal (MB) are switched at each one vertical period (frame) to perform the frame inversion drive during partial display periods (“B” to “F”). Accordingly, image deterioration can be avoided while realizing low power consumption by time-division drive.

### Embodiment 4

FIG. 11 is a block diagram showing a schematic configuration of a scanning line drive circuit of an embodiment 4 of the invention.

The embodiment is the circuit in which selection signals (SEL, SELB), second alternation signals (MS, MSB) and transistors (M5, M5′, M6, M6′) are newly added to the embodiment 2.

Though the method of driving gates is the same as the above embodiment 2, the embodiment is different from the embodiment 2 in a point that different enable signals are inputted to counter electrode scanning circuits (C-1 to C-2n) at a display period and a non-display period.

Input switching between the display period and the non-display period is performed by the newly added selection signals (SEL, SELB).

During a period when gate scanning is performed, for example, at the time of a normal display and in a display part at the time of a partial display, the selection signal SEL is fixed at the H-level and the selection signal SELB is fixed at the L-level. Accordingly, the transistors (M5, M5′) are turned on, and the transistors (M6, M6′) are turned off.

When the transistors (M5) are on, the scanning line drive clock (V1-G) is inputted in every other counter electrode scanning circuit (C-1, C-3, C-5, . . . ) through the transistors (M1) to be enable signals (E-1, E-3, E-5, . . . ).

Similarly, when the transistors (M5′) are on, the scanning line drive clock (V2-G) is inputted in every other counter electrode scanning circuit (C-2, C-4, C-6, . . . ) through the transistors (M4) to be enable signals (E-2, E-4. E-6 . . . ).

Since gate scanning is sequentially performed by one step, output operation of the common voltage outputted from the counter electrode scanning circuits (C-1 to C-2n) to the counter electrodes (ITO2) is sequentially performed by one step.

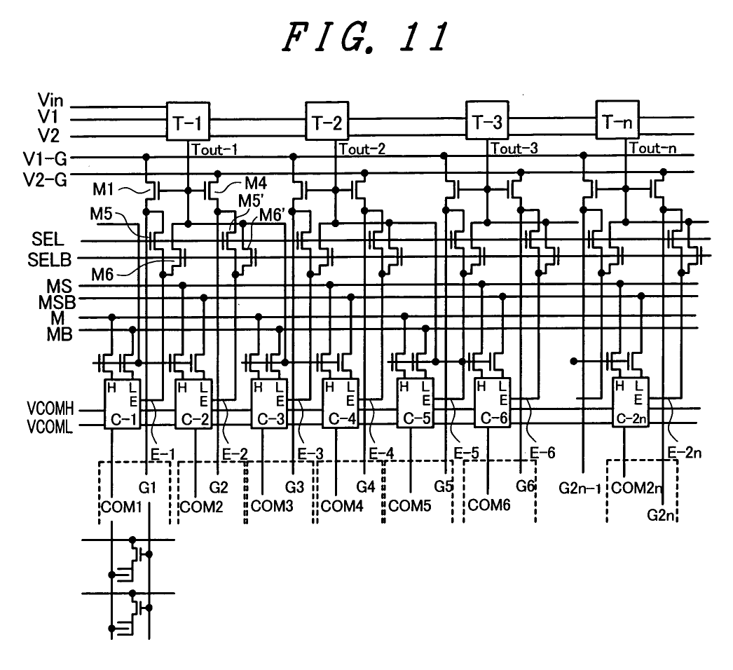

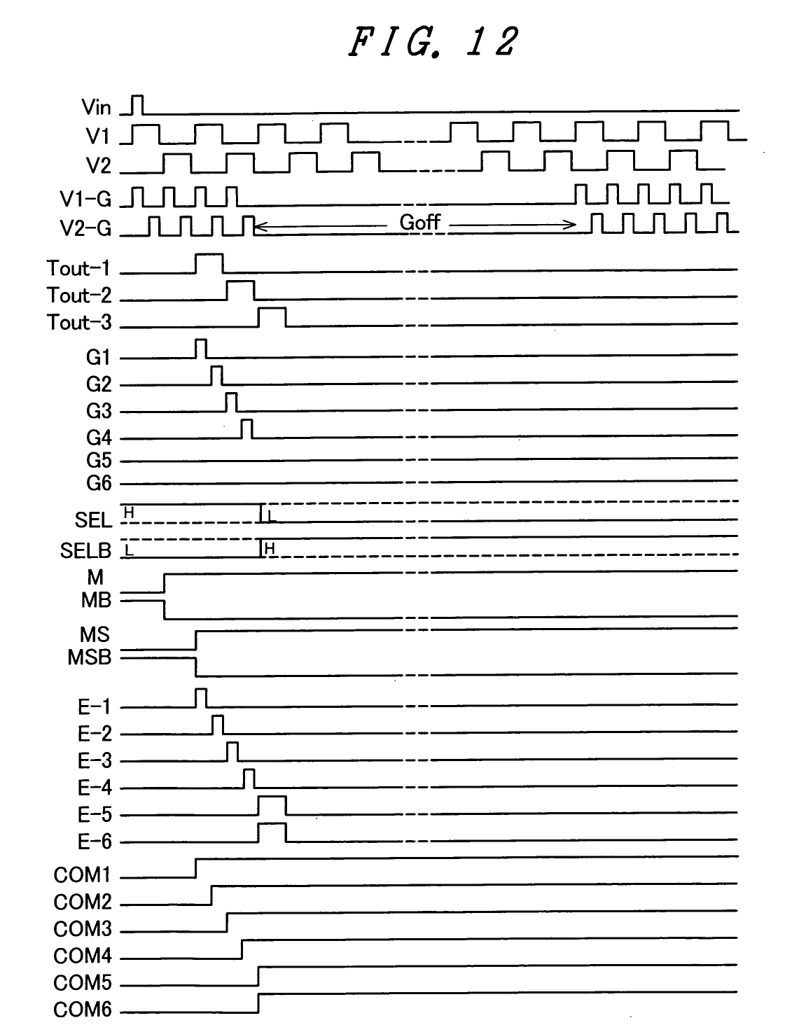

During a period when gate scanning is not performed in the partial display period (a later-described Goff period in FIG. 12), the selection signal SEL is fixed at the L-level, the selection signal SELB is fixed at the H-level, transistors (M5, M5′) are turned off and transistors (M6, M6′) are turned on.

Shift pulses (Tout-1 to Tout-n) are inputted to drains of the transistors (M6, M6′) outputted from shift register circuits (T-1 to T-n). Therefore, the shift pulses (Tout-1 to Tout-n) become enable signals (E-1 to E-2n) of the counter electrode scanning circuits (C-1 to C-2n).

Since the same shift pulse is inputted to respective two adjacent stages of counter electrode scanning circuits as enable signals, output operations from the respective two adjacent stages of counter electrode scanning circuits are performed simultaneously. Accordingly, output is simultaneously performed at two lines, however, writing is not performed into subpixels during the partial display period, and image deterioration by the simultaneous output of two lines does not matter on the display.

Accordingly, in the embodiment, as enable signals to be inputted to the counter electrode scanning circuits (C-1 to C-2n), the scanning line drive clocks (V1-G, V2-G) are used during the period when gate scanning is performed, and the shift pulses (Tout-1 to Tout-n) are used during the period when gate scanning is not performed, as a result, the counter electrode scanning circuits can be driven without using common control clocks (V1-C, V2-C) and without deteriorating image quality of the display part.

In order to determine the H-level common voltage (VCOMH) or the L-level common voltage (VCOML), the shift pulses (Tout-1 to Tout-n) are used, and determination is performed at two lines simultaneously.

Therefore, it is difficult to realize inversion of common polarity by each line only by the alternation signal (M) and the inverting alternation signal (MB), and it is necessary to newly add an alternation signal (MS) and an inverting alternation signal (MBS).

The first alternation signal (M) and the first inverting alternation signal (MB) determine the polarity of the counter electrode scanning circuits (C-1, C-3, . . . ) and the second alternation signal (MS) and the second inverting alternation signal (MSB) determine the polarity of the counter electrode scanning circuits (C-2, C-4, . . . ).

The first alternation signal (M) and the first inverting alternation signal (MB), and the second alternation signal (MS) and the second inverting alternation signal (MSB) are signals having opposite phases respectively.

When the first alternation signal (M) is allowed to be the same phase as the second alternation signal (MS), respective two adjacent stages of counter electrode scanning circuits (for example, C-1 and C-2) have the same polarity.

When the first alternation signal (M) and the second alternation signal (MS) are allowed to be opposite phases, respective two adjacent stages of counter electrode scanning circuits (for example, C-1 and C-2) have opposite polarity.

Therefore, the frame inversion and the line inversion can be arbitrarily controlled by controlling the first alternation signal (M), the first inverting alternation signal (MB), the second alternation signal (MS) and the second inverting alternation signal (MSB).

FIG. 12 is a view showing a timing chart in one frame at the time of partial display drive in the scanning line drive circuit shown in FIG. 11.

As shown in FIG. 12, during a period when gate scanning is performed, scanning line drive clocks (V1-G, V2-G) are outputted, the selection signal (SEL) is fixed at the H-level, and the selection signal (SELB) is fixed at the L-level.

During a period when gate scanning is not performed (Goff period in FIG. 12), the scanning line drive clocks (V1-G, V2-G) are fixed at the L-level. During the period, the selection signal (SEL) is fixed at the L-level and the selection signal (SELB) is fixed at the H-level.

The first alternation signal (M), the second alternation signal (MS), and the first inverting alternation signal (MB), the second inverting alternation signal (MSB) have the same polarity as each other and fixed for one vertical period (frame), which have waveforms of the frame inversion drive.

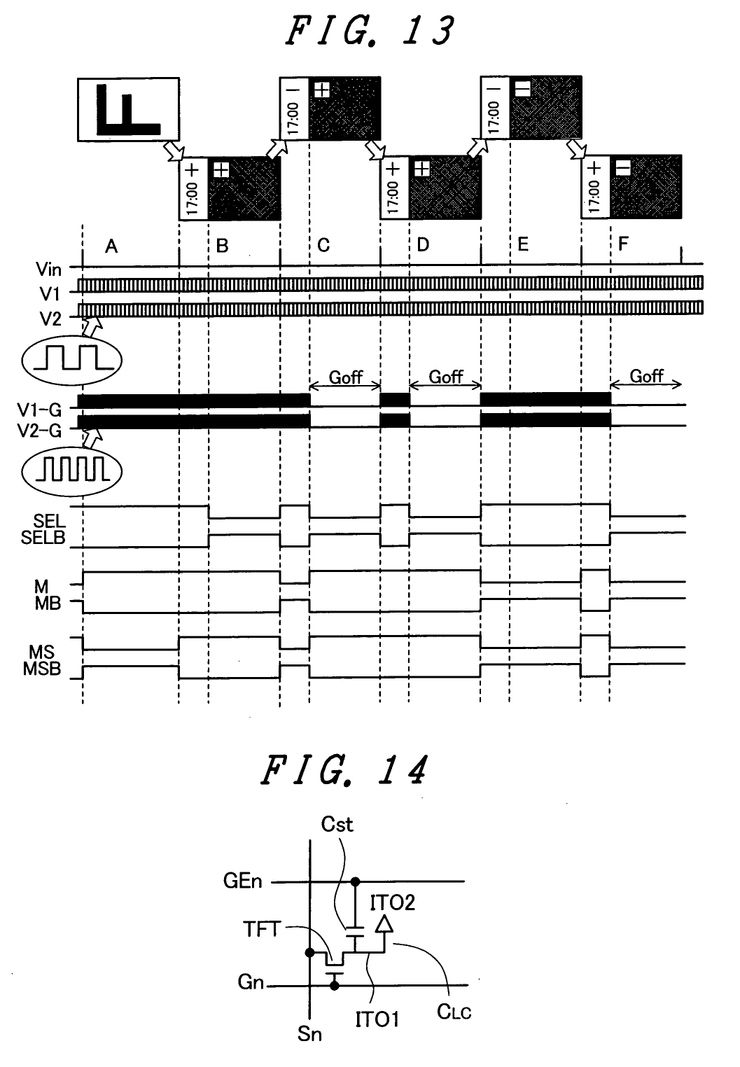

FIG. 13 is a view showing a timing chart of the normal display drive and five frames of partial display drive in the scanning line drive circuit shown in FIG. 11.

In FIG. 13, “A” is the normal display period, which is the line inversion period (one line inversion). “B” to “F” are partial display periods, where there are periods (Goff periods in FIG. 13) when gate scanning is not performed in the second and third frames (C, D).

The first alternation signal (M), the second alternation signal (MS), and the first inverting alternation signal (MB), the second inverting alternation signal (MSB) have opposite phases to each other in the normal display period (“A”) for achieving the line inversion, and have the same phase as each other for achieving the frame inversion.

Accordingly, also in the embodiment, the partial display can be performed without affecting image quality of the display part without using the common control clocks (V1-C, V2-C), and power consumption can be reduced by reducing the increase of power consumption caused by common control clocks (V1-C, V2-C).

### Embodiment 5

As a method of driving a liquid crystal display device, an independent charge-coupling driving method is known. (For example, refer to Patent document 2.)

FIG. 14 is a circuit diagram showing an equivalent circuit of a subpixel of the independent charge-coupling driving liquid crystal display panel.

In FIG. 14, “Gn” denotes a scanning line, “Sn” denotes a video line, “GEn” denotes a compensation line, “CLC” denotes a liquid crystal capacitor, “Cst” denotes a storage capacitor, “TFT” denotes a thin-film transistor, “ITO1” denotes a pixel electrode and “ITO2” denotes a counter electrode. In FIG. 14, the pixel electrode (ITO1) and the counter electrode (ITO2) are provided opposite to each other, sandwiching liquid crystal, therefore, the electric field is applied in a direction orthogonal to the substrate.

In the independent charge-coupling driving method, the thin-film transistors are turned on by applying a scanning voltage to the scanning lines (Gn), and a video voltage is applied to pixel electrodes (ITO1) from the video line (Sn) for one display period. After that, the thin-film transistors (TFT) are turned off, and a compensation voltage is applied to the compensation line (GEn).

Accordingly, in the independent charge-coupling driving method, a voltage to be written to respective subpixels is determined by the video voltage applied from the video line (Sn) and the compensation voltage applied from the compensation line (GEn).

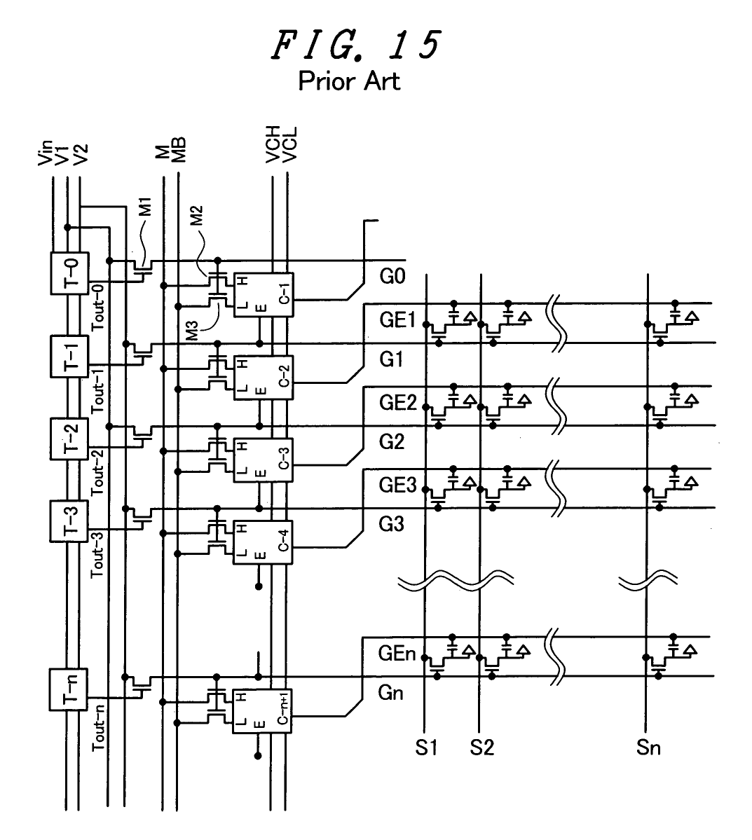

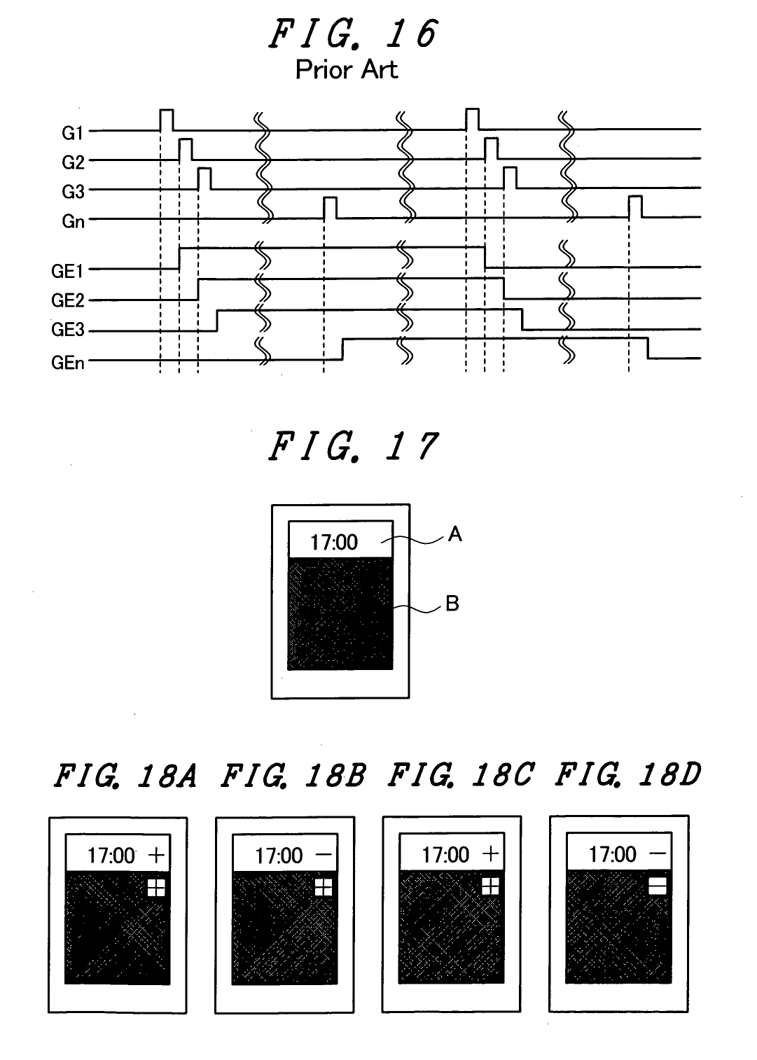

FIG. 15 is a block diagram showing a schematic configuration of a scanning line drive circuit which drives a conventional independent charge-coupling driving liquid crystal display panel. FIG. 16 is a view showing a timing chart of the scanning line drive circuit shown in FIG. 15.

In FIG. 15, for example, a counter electrode scanning circuit (C-2) determines which of an H-level compensation voltage (VCH) and an L-level compensation voltage (VCL) is outputted based on an alternation signal (M) and an inverting alternation signal (MB) inputted through transistors (M2, M3) which are turned on by the transfer clock (V2), and outputs either the H-level or the L-level compensation voltage to a previous-stage compensation line (GE1) by inputting a transfer clock (V1) as an enable signal (E).

The invention can be also applied to the independent charge-coupling driving liquid crystal display panel. In this case, in the above respective embodiments, either the H-level or the L-level compensation voltage may be outputted to the previous-stage compensation line from each counter electrode scanning circuit (C-1 to C-n+1).

In FIG. 15, since a shift register circuit (T-0) and the counter electrode scanning circuit (C-1) are independent for the operation of the display panel, it is possible to omit the shift register circuit (T-0), the counter electrode scanning circuit (C-1) and the transistors (M1, M2, M3) whose inputs are outputs thereof.

The invention made by the present inventors has been specifically explained based on the embodiments, however, the invention is not limited to the above embodiments, and it will be evident that various modifications may be made in the scope not departing from the gist thereof.

What is claimed is:

1. A display device, comprising:
a display panel having
a plurality of pixels,
a plurality of scanning lines which apply scanning voltages to the plurality of pixels, and
a plurality of signal lines formed along the extending direction of the plurality of scanning lines, which apply prescribed voltages to the plurality of pixels; and
a drive circuit which drives the display panel, and
wherein the drive circuit includes
shift register circuits which sequentially output a first to the order of “n” (n≧2) shift pulses at each prescribed period based on transfer clocks to be inputted,
“n” pieces of first transistors in which the first to the order of “n” shift pulses outputted from the shift resister circuits are inputted to gates respectively, and
“n” pieces of signal line scanning circuits,
wherein the respective first transistors perform sampling of scanning line drive clocks and output them as the scanning voltages for a first to the order of “n” scanning lines based on the first to the order of “n” shift pulses outputted from the shift resistor circuits, and
wherein the respective signal line scanning circuits output the prescribed voltages for a first to the order of “n” signal lines based on the first to the order of “n” shift pulses outputted from the shift register circuits, an alternation signal, an inverting alternation signal and the transfer clocks.

2. The display device according to claim 1,
wherein the order of “k” (1≦k≦n) signal line scanning circuit selects the prescribed voltage for the order of “k” signal line based on the order of (k−1) shift pulse outputted from the shift register circuit, the alternation signal, the inverting alternation signal and the transfer clock, and outputs the selected voltage based on the order of “k” shift pulse outputted from the shift register circuit and the transfer clock.

3. The display device according to claim 1, further includes,
“n” pieces of second transistors in which the first to the order of “n” shift pulses outputted from the shift resister circuits are inputted to gates respectively, and
“n” pieces of third transistors and fourth transistors provided at respective signal line scanning circuits, and
wherein the order of “k” second transistor performs sampling of the transfer clock and inputs it as an enable signal to the order of “k” signal line scanning circuit based on the shift pulse outputted from the order of “k” shift resistor circuit,
wherein the order of “k” third transistor performs sampling of the alternation signal and inputs it to the order of “k” signal line scanning circuit based on the transfer clock sampled by the order of (k−1) second transistor, and
wherein the order of “k” fourth transistor performs sampling of the inverting alternation signal and inputs it to the order of “k” signal line scanning circuit based on the transfer clock sampled by the order of (k−1) second transistor.

4. The display device according to claim 3,
wherein the transfer clocks are a first transfer clock and a second transfer clock having the same cycle and different phases, and one of the two adjacent second transistors perform sampling of the first transfer clock and the other of the two adjacent second transistors performs sampling of the second transfer clock.

5. The display device according to claim 1,
wherein the scanning line drive clocks are a first scanning line drive clock and a second scanning line drive clock having the same cycle and different phases, and one of the two adjacent first transistors performs sampling of the first scanning line drive clock and the other of the two adjacent first transistors performs sampling of the second scanning line drive clock.

6. A display device, comprising:
a display panel having
a plurality of pixels,
a plurality of scanning lines which apply scanning voltages to the plurality of pixels, and
a plurality of signal lines formed along the extending direction of the plurality of scanning lines, which apply prescribed voltages to the plurality of pixels; and
a drive circuit which drives the display panel, and
wherein the drive circuit includes
shift register circuits which sequentially output a first to the order of “n” (n≧2) shift pulses at each prescribed period based on transfer clocks to be inputted,
“n” pieces of first to the order of “j” (j≧2) transistors in which the first to the order of “n” shift pulses outputted from the shift resister circuits are inputted to gates respectively, and
“j×n” pieces of signal line scanning circuits,
wherein the respective first to the order of “j” transistors perform sampling of a first to the order of “j” scanning line drive clocks respectively and output them as the scanning voltages for a first to the order of “j×n” scanning lines based on the first to the order of “n” shift pulses outputted from the shift resistor circuits, and
wherein the respective signal line scanning circuits output the prescribed voltages for a first to the order of “j×n” signal lines based on the first to the order of “n” shift pulses outputted from the shift resister circuits, an alternation signal, an inverting alternation signal and the transfer clocks.

7. The display device according to claim 1,
wherein the scanning line drive clocks have off-periods fixed at a first voltage level or at a second voltage level within one frame period.

8. A display device, comprising:
a display panel having
a plurality of pixels,
a plurality of scanning lines which apply scanning voltages to the plurality of pixels, and
a plurality of signal lines formed along the extending direction of the plurality of scanning lines, which apply prescribed voltages to the plurality of pixels; and
a drive circuit which drives the display panel, and
wherein the drive circuit includes
shift register circuits which sequentially output a first to the order of “n” (n≧2) shift pulses at each prescribed period based on transfer clocks to be inputted,
“n” pieces of first transistors and second transistors in which the first to the order of “n” shift pulses outputted from the shift resister circuits are inputted to gates respectively, and
“2n” pieces of signal line scanning circuits, and
wherein the order of “k” (1≦k≦n) first transistor performs sampling of a first scanning line drive clock and output it as the scanning voltage for the order of a (2k−1) scanning line based on the order of “k” shift pulse outputted from the shift resistor circuit, and
wherein the order of “k” second transistor performs sampling of a second scanning line drive clock which has the same cycle as, and a different phase from the first scanning line drive clock and outputs it as the scanning voltage for the order of “2k” scanning line based on the order of “k” shift pulse outputted from the shift register circuit, and
wherein the order of (2k−1) and the order of “2k” signal line scanning circuits output the prescribed voltages for the order of (2k−1) and the order of “2k” signal lines based on the order of (k−1) and the order of “k” shift pulses outputted from the shift register circuits, an alternation signal, an inverting alternation signal and the transfer clocks.

9. The display device according to claim 8,
wherein the order of (2k−1) and the order of “2k” signal line scanning circuit select the prescribed voltages for the order of (2k−1) and the order of “2k” signal lines based on the order of (k−1) shift pulse outputted from the shift register circuit, the alternation signal, the inverting alternation signal and the transfer clocks, and output the selected voltages based on the order of “k” shift pulse outputted from the shift register circuit and the transfer clocks.

10. The display device according to claim 8, further includes
“n” pieces of third transistors in which the first to the order of “n” shift pulses outputted from the shift register circuits are applied to gates respectively, and
“2n” pieces of fourth transistors and fifth transistors provided at respective signal line scanning circuits, and
wherein the order of “k” third transistor performs sampling of the transfer clocks and inputs them to the order of (2k−1) and the order of “2k” signal line scanning circuits as enable signals based on the order of “k” shift pulse outputted from the shift resistor circuit,
wherein the order of (2k−1) fourth transistor performs sampling of the alternation signal and inputs it to the order of (2k−1) signal line scanning circuit based on the transfer clock sampled in the order of (k−1) third transistor,
wherein the order of (2k−1) fifth transistor performs sampling of the inverting alternation signal and inputs it to the order of (2k−1) signal line scanning circuit based on the transfer clock sampled in the (k−1) third transistor,
wherein the order of “2k” fourth transistor performs sampling of the alternation signal and inputs it to the order of “2k” signal line scanning circuit based on the transfer clock sampled in the (k−1) third transistor, and
wherein the order of “2k” fifth transistor performs sampling of the inverting alternation signal and inputs it to the order of “2k” signal line scanning circuit based on the transfer clock sampled in the (k−1) third transistor.

11. The display device according to claim 10,
wherein the transfer clocks are a first transfer clock and a second transfer clock having the same cycle and different phases, and one of the two adjacent third transistors performs sampling of the first transfer clock and the other of the two adjacent third transistors performs sampling the second transfer clock.

12. A display device, comprising:
a display panel having
a plurality of pixels,
a plurality of scanning lines which apply scanning voltages to the plurality of pixels, and
a plurality of signal lines formed along the extending direction of the plurality of scanning lines, which apply prescribed voltages to the plurality of pixels; and
a drive circuit which drives the display panel, and
wherein the drive circuit includes
shift register circuits which sequentially output a first to the order of “n” (n≧2) shift pulses at each prescribed period based on transfer clocks to be inputted,
“n” pieces of first transistors and second transistors in which the first to the order of “n” shift pulses outputted from the shift resister circuits are inputted to gates respectively, and
“2n” pieces of signal line scanning circuits, and
wherein the order of “k” (1≦k≦n) first transistor performs sampling of a first scanning line drive clock and output it as the scanning voltage for the order of a (2k−1) scanning line based on the order of “k” shift pulse outputted from the shift resistor circuit,
wherein the order of “k” second transistor performs sampling of a second scanning line drive clock which has the same cycle as, and a different phase from the first scanning line drive clock and outputs it as the scanning voltage for the order of “2k” scanning line based on the order of “k” shift pulse outputted from the shift register circuit, and
wherein the order of (2k−1) and the order of “2k” signal line scanning circuits output the prescribed voltages for the order of (2k−1) and the order of “2k” signal lines based on the order of (k−1) and the order of “k” shift pulses outputted from the shift register circuits, an alternation signal, an inverting alternation signal, a first signal line drive clock and a second signal line drive clock which has the same cycle as, and a different phase from the first signal line drive clock.

13. The display device according to claim 12,
wherein the (2k−1) signal line scanning circuit selects the prescribed voltage for the order of (2k−1) signal line based on the order of (k−1) shift pulse outputted from the shift register circuit, the alternation signal, the inverting alternation signal and the second signal line drive clock, and outputs the selected voltage based on the order of “k” shift pulse outputted from the shift resister circuit and the first signal line drive clock, and
wherein the order of “2k” signal line scanning circuit selects the prescribed voltage for the order of “2k” signal line based on the order of “k” shift pulse outputted from the shift resister circuit, the alternation signal, the inverting alternation signal and the first signal line drive clock, and outputs the selected voltage based on the order of “k” shift pulse outputted from the shift resister circuit and the second signal line drive clock.

14. The display device according to claim 12, further includes
“n” pieces of third transistors and forth transistors in which the first to the order of “n” shift pulses outputted from the shift resister circuits are applied to gates respectively, and
“2n” pieces of fifth transistors and the sixth transistors provided at respective “2n” pieces of signal line scanning circuits, and
wherein the order of “k” third transistor performs sampling of the first signal line drive clock and inputs it to the order of (2k−1) signal line scanning circuit as an enable signal based on the order of “k” shift pulse outputted from the shift resister circuit,
wherein the order of “k” fourth transistor performs sampling of the second signal line drive clock and inputs it to the order of “2k” signal line scanning circuit as an enable signal based on the order of “k” shift pulse outputted from the shift resister circuit,
wherein the order of (2k−1) fifth transistor performs sampling of the alternation signal and inputs it to the order of (2k−1) signal line scanning circuit based on the second signal line drive clock sampled in the order of (k−1) fourth transistor,
wherein the order of (2k−1) sixth transistor performs sampling of the inverting alternation signal and inputs it to the (2k−1) signal line scanning circuit based on the second signal line drive clock sampled in the order of (k−1) fourth transistor,
wherein the order of “2k” fifth transistor performs sampling of the alternation signal and inputs it to the order of “2k” signal line scanning circuit based on the first signal line drive clock sampled in the order of “k” third transistor, and
wherein the order of “2k” sixth transistor performs sampling of the inverting alternation signal and inputs it to the order of “2k” signal line scanning circuit based on the first signal line drive clock sampled at the order of “k” third transistor.

15. The display device according to claim 8,
wherein the first and second scanning line drive clocks have off-periods fixed at a first voltage level or at a second voltage level in one frame period.

16. A display device, comprising:
a display panel having
a plurality of pixels,
a plurality of scanning lines which apply scanning voltages to the plurality of pixels, and
a plurality of signal lines formed along the extending direction of the plurality of scanning lines, which apply prescribed voltages to the plurality of pixels; and
a drive circuit which drives the display panel, and
wherein the drive circuit includes
shift register circuits which sequentially output a first to the order of “n” (n≧2) shift pulses at each prescribed period based on transfer clocks to be inputted,
“n” pieces of first transistors and second transistors in which the first to the order of “n” shift pulses outputted from the shift resister circuits are inputted to gates respectively,
“n” pieces of third transistors and fourth transistors in which a selection signal is applied to gates respectively,
“n” pieces of fifth transistors and sixth transistors in which an inverting selection signal is applied to gates respectively, and
“2n” pieces of signal line scanning circuits, and
wherein the order of “k” (1≦k≦n) first transistor performs sampling of a first scanning line drive clock and output it as the scanning voltage for the order of (2k−1) scanning line based on the order of “k” shift pulse outputted from the shift resistor circuit,
wherein the order of “k” second transistor performs sampling of a second scanning line drive clock which has the same cycle as, and a different phase from the first scanning line drive clock and outputs it as the scanning voltage for the order of “2k” scanning line based on the order of “k” shift pulse outputted from the shift register circuit,
wherein the order of “k” third transistor inputs the first scanning line drive clock sampled in the order of “k” first transistor to the order of (2k−1) signal line scanning circuit as an enable signal based on the selection signal,
wherein the order of “k” fourth transistor inputs the second scanning line drive clock sampled in the order of “k” second transistor to the order of “2k” signal line scanning circuit as an enable signal based on the selection signal,
wherein the order of “k” fifth transistor inputs the order of “k” shift pulse outputted from the shift register circuit to the order of (2k−1) signal line scanning circuit as an enable signal based on the inverting selection signal,
wherein the order of “k” sixth transistor inputs the order of “k” shift pulse outputted from the shift register circuit to the order of “2k” signal line scanning circuit as an enable signal based on the inverting selection signal, and
wherein the order of (2k−1) and the order of “2k” signal line scanning circuits output the prescribed voltages for the order of (2k−1) and the order of “2k” signal lines based on the order of (k−1) and the order of “k” shift pulses outputted from the shift register circuits, a first alternation signal, an inverting first alternation signal, a second alternation signal, an inverting second alternation signal and the first and second scanning line drive clocks.

17. The display device according to claim 16,
wherein the order of (2k−1) signal line scanning circuit selects the prescribed voltage for the order of (2k−1) signal line based on the shift pulse outputted from the order of (k−1) shift register circuit, the first alternation signal and the inverting first alternation signal and outputs the selected voltage based on the first scanning line drive clock or the order of “k” shift pulse outputted from the shift register circuit, and
wherein the order of “2k” signal line scanning circuit selects the prescribed voltage for the order of “2k” signal line based on the shift pulse outputted from the order of (k−1) shift register circuit, the second alternation signal and the inverting second alternation signal, and outputs the selected voltage based on the second scanning line drive clock or the order of “k” shift pulse outputted from the shift register circuit.

18. The display device according to claim 16, further includes
“2n” pieces of seventh transistors and eighth transistors provided at respective “2n” pieces of signal line scanning circuits, and
wherein the order of (2k−1) seventh transistor performs sampling of the first alternation signal and inputs it to the order of (2k−1) signal line scanning circuit based on the order of (k−1) shift pulse outputted from the shift register circuit,
wherein the order of (2k−1) eighth transistor performs sampling of the inverting first alternation signal and inputs it to the order of (2k−1) signal line scanning circuit based on the order of (k−1) shift pulse outputted from the shift register circuit,
wherein the order of “2k” seventh transistor performs sampling of the second alternation signal and inputs it to the order of “2k” signal line scanning circuit based on the order of (k−1) shift pulse outputted from the shift register circuit, and
wherein the order of “2k” eighth transistor performs sampling of the inverting second alternation signal and inputs it to the order of “2k” signal line scanning circuit based on the order of (k−1) shift pulse outputted from the shift register circuit.

19. The display device according to claim 18,
wherein the transfer clocks are a first transfer clock and a second transfer clock having the same cycle and different phases.

20. The display device according to claim 16,
wherein the first and second scanning line drive clocks have off-periods fixed at a first voltage level or at a second voltage level in one frame period.

21. The display device according to claim 20,
wherein during the off-period of the first and second scanning line drive clocks, the selection signal is at a third voltage level, the inverting selection signal is at a fourth voltage level, and during periods other than the off-period of the first and second scanning line drive clocks, the selection signal is at the fourth voltage level and the inverting selection signal is at the third voltage level.

22. The display device according to claim 20,
wherein during the off-period of the first and second scanning line drive clocks, the first alternation signal and the second alternation signal have the same phase.

23. The display device according to claim 16,
wherein during a normal display period, the first alternation signal and the second alternation signal have opposite phases, and during a partial display period, the first alternation signal and the second alternation signal have the same phase.

24. The display device according to claim 7,
wherein an amplitude level of the transfer clocks during the off-period is lower than an amplitude level of the transfer clocks during periods other than the off-period.

25. The display device according to claim 1,
wherein the signal line is a counter electrode line, and the prescribed voltages are a counter voltage at a first voltage level and a counter voltage at a second voltage level.

26. The display device according to claim 1,
wherein the signal line is a compensation signal line applying a compensation voltage to each pixel.
